(19) United States
(12) Patent Application Publication
(10) Pub. No.: US 2006/0179484 A1
(43) Pub. Date: Aug. 10, 2006

(54) Remediating effects of an undesired application

(76) Inventors: John P. Scrimsher, Albany, OR (US); Daniel Madden, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/054,028

(22) Filed: Feb. 9, 2005

(51) Int. Cl. G06F 12/14

(52) U.S. Cl. 726/23

(57) ABSTRACT

Remediating effects of an undesired application. A remediation system comprises a script generator and a fix tool builder. The script generator is able to generate a script comprising remediation information corresponding to one or more actions for remediating one or more effects of the undesired application. The fix tool builder is able to generate a fix tool for performing the actions.

### BACKGROUND

Computer systems are often vulnerable to malicious software (“malware”), such as viruses, worms, and the like. Harmful effects of malware may include loss or unauthorized modification of data, damage to computer equipment, breaches of security, and significant costs in time and money for identifying and removing the malware and remediating its effects.

Frequently, malware is created by individuals without significant programming knowledge (sometimes known as “script kiddies”) that may, for example, generate viruses using ready-made tools such as viral toolkits. Viral toolkits are readily available for downloading from the Internet, such as at web sites frequented by malicious hackers and script kiddies. Such persons, using a viral toolkit or other malware generator, may easily be able to generate new threats to the security of multiple computer systems. The transmission of malware from one computer to another frequently results in localized or widespread outbreaks. To reach the greatest possible number of computer systems, viral toolkits are most commonly designed to generate malware targeted to computer systems that run a recent version of Microsoft Windows operating systems, rather than a competing operating system such as Unix or Linux.

Technologies have been developed by commercial security solution providers and anti-malware solution providers (collectively, “antivirus vendors”) to detect new malware. For example, an intrusion detection system (“IDS”) may include honeypot technologies designed to detect and identify intruders; such honeypot technologies have had some success in capturing samples of malware. Most commonly, malware is identified by affected computer users, system or network administrators, and the like (collectively, “affected entities”) upon experiencing harmful effects of malware. The initial discovery by an affected entity can sometimes be hours or days after the first infection. For example, a new malware may be identified after an affected entity notices symptoms such as an increase in network traffic, or increased CPU utilization on some computers. Affected entities may then suspect malware and, after some investigation, may provide samples of suspicious code to an antivirus vendor for analysis.

While conventional antivirus software is designed to detect and block known malware, such antivirus software generally does not clean up or remediate effects of the malware (such as registry changes, other file changes that are not in themselves viral, service manipulation and the like). To help with remediation of the effects of a malware-related incident, antivirus vendors may create a tool (commonly known as a “fix tool”) that is tailored to a specific malware. To prepare a fix tool, antivirus vendors generally analyze the malware by reverse engineering suspicious code, and may also undertake an after-the-fact analysis of effects caused by the malware. Such analysis requires time and resources that are not always readily available, and can lead to delays in providing a response to affected entities. After an antivirus vendor obtains a sample of a newly-discovered malware, it may take hours or days for the antivirus vendor to analyze the sample, develop an appropriate response, and create and distribute a fix tool for helping to remediate the effects of the malware.

In some cases, the antivirus vendor may be able to supply documentation for manual clean-up procedures within the first few hours; however, affected entities then have to manually perform the clean-up procedures, or develop their own automated script for the clean-up procedures, while awaiting the release of an official vendor-provided fix tool. As used herein, “script” includes a computer program comprising any form or format of code. This can be time-consuming or impossible for affected entities that do not have significant programming resources.

Even for affected entities that have programming resources available for fighting a malware outbreak, significant delays may often occur before a fix tool is available. In a typical process, the affected entities wait for antivirus vendors to document what a malware does. The affected entities may provide feedback and/or corrections to the antivirus vendors, as the affected entities independently find more information. The affected entities may also wait for one or more antivirus vendors or others, such as participants in malware-related newsgroups or online forums, to post information. Information for preventing the further spread of the malware (e.g., information regarding IDS signatures, or modules for remote network scanners such as Nessus) may often be considered more urgent than developing or posting remediation or clean-up procedures. Waiting for remediation information and fix tools to be provided by an antivirus vendor may put resources of affected entities at risk.

Reverse engineering of malware, such as by disassembling executable code of the malware and/or examining source code of the malware, is the most common way for antivirus vendors to discover effects of the malware that may require remediation. However, reverse engineering requires considerable time and specialized programming skills, and is often impossible or impractical for personnel of an affected entity. Upon discovering remediable effects of the malware, preparation of a fix tool may also require significant time and programming resources that may be unavailable to an affected entity.

### SUMMARY

In one embodiment, the invention comprises a system for remediating effects of an undesired application. The system comprises a script generator and a fix tool builder. The script generator is able to generate a script comprising remediation information corresponding to one or more actions for remediating one or more effects of the undesired application. The fix tool builder is able to generate a fix tool for performing the actions.

In another embodiment, the invention comprises a method for remediating effects of an undesired application. One or more hook functions are provided, and one or more system calls are hooked. Descriptive information is gathered concerning the one or more system calls. A log is generated comprising at least a portion of the descriptive information. A script is generated comprising remediation information for at least a portion of the log. A fix tool is built that is able to perform remediation actions according to the script.

The foregoing presents a simplified summary of the invention in order to provide a basic understanding of some aspects of the invention. This summary is not an extensive overview of the invention, and is intended to neither identify key or critical elements of the invention nor delineate the scope of the invention. Other features of the invention are further described below.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1A is a diagram illustrating data flow for an embodiment of the invention.

FIG. 1B is a diagram illustrating data flow for a further embodiment of the invention.

FIG. 2 is a diagram of a computer system implementing a monitoring system according to an illustrative embodiment of the invention.

FIG. 3 is a diagram of an administration application configured to generate a fix tool according to an illustrative embodiment of the invention.

FIG. 4 is a flow chart of a method for remediating effects of a malware according to an embodiment of the present invention.

FIG. 5 is a depiction of a user interface for a fix tool according to an embodiment of the invention.

FIG. 6 is a depiction of an exemplary user interface for design functionality and build functionality of an administration application according to an embodiment of the invention.

FIG. 7 is a depiction of an exemplary user interface for an administration application, illustrating registry management features according to an alternate embodiment of the invention.

FIG. 8 is a depiction of an exemplary user interface for an administration application, illustrating service analysis features according to an alternate embodiment of the invention.

FIG. 9 is a depiction of an exemplary user interface for an administration application, illustrating service installer features according to an alternate embodiment of the invention.

FIG. 10 is a depiction of an exemplary user interface for an administration application, illustrating process start features according to an alternate embodiment of the invention.

FIG. 11 is a depiction of an exemplary user interface for an administration application, illustrating privilege features according to an alternate embodiment of the invention.

FIG. 12 is a depiction of an exemplary user interface for an administration application, illustrating analysis functionality according to an alternate embodiment of the invention.

### DETAILED DESCRIPTION

The tools provided in embodiments of the present invention are designed to monitor live malware to determine what actions it is taking on a system, and to assist in the creation of a fix tool for dissemination to end users. Such tools may, for example, allow personnel responsible for combating malware (such as information security personnel of an affected entity) to generate fix tools for viruses and other malware, without having to write in a standard programming language. By allowing faster generation and distribution of fix tools, affected entities are empowered to provide a fast response to malware outbreaks. The tools provided in embodiments of the invention may also be used for removal of applications that are not necessarily classified as malware (such as adware and spyware), as well as general application removal.

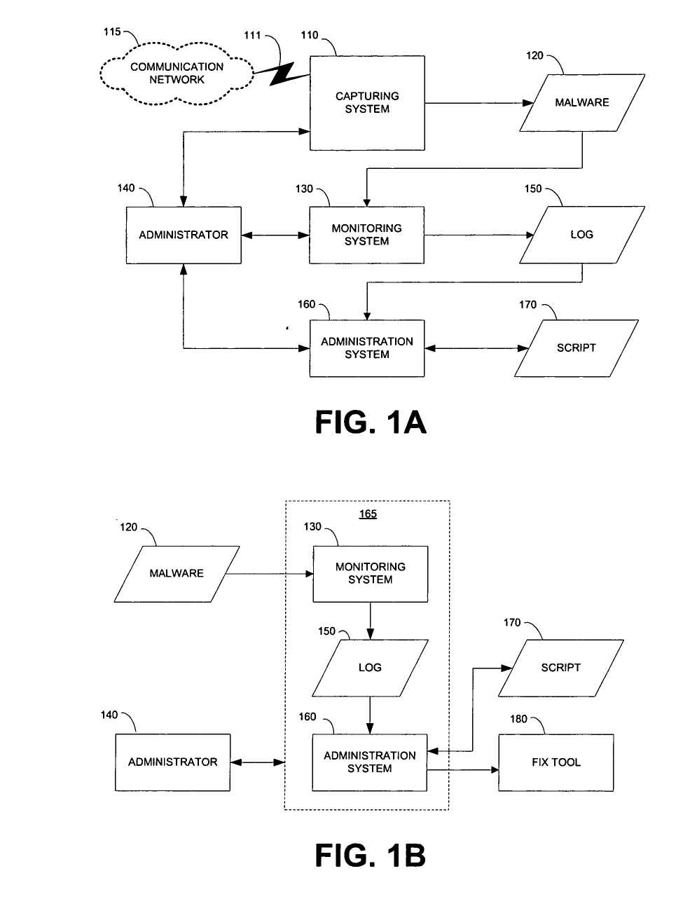

Referring to the drawings, in which like reference numerals indicate like elements, FIG. 1A illustrates data flow for an embodiment of the invention that may be implemented using three computers. A capturing system 110 is provided on a first computer to obtain or trap malicious software such as malware 120. A monitoring system 130 is provided on a second computer for running the malware 120 under controlled conditions to generate a record (such as a log 150) describing behavior of the malware 120. An administration system 160 is provided on a third computer that is able to allow a human administrator 140 to perform administrative functions, such as reviewing the log 150, and creating and/or modifying a script 170 that is generated using the log 150. For ease of illustration, one administrator 140 is depicted, but it will be appreciated that the functions of administrator 140 may readily be shared or distributed among a plurality of administrators 140.

In some implementations, the capturing system 110 is configured to attract malicious computer users and malware 120, such as by the use of conventional honeypot technologies. In other implementations, an exemplary capturing system 110 may be configured to receive electronic mail that may contain malware 120, such as by retrieving electronic mail for one or more email addresses that are published on the Internet or otherwise disseminated for purposes of attracting spam. An exemplary capturing system 110 is communicatively coupled by a communication link 111 to a communication network 115, such as the Internet, a local or wide-area network, or the like, and may be able to receive malware 120 from the communication network 115.

The capturing system 110 may also record information (such as an IP address or other system identifier) associated with receiving the malware 120. Such information may be useful in identifying an originating system from which the malware 120 was received, so that the administrator 140 or other remediation personnel may prioritize such originating system for remediation actions, thereby preventing further attacks from the originating system.

The malware 120 may be transferred or introduced into the monitoring system 130 from the capturing system 110, or from sources other than the capturing system 110 (such as a sample obtained from a different computer affected by the malware 120, or obtained from an antivirus vendor or other trusted source). The malware 120 may be transferred or introduced into the monitoring system 130 by any of numerous means, such as network transfer over a communication link, or physical transfer (e.g., via magnetic or optical media). In some implementations, the monitoring system 130 may be communicatively coupled to the capturing system 110; however, for greater security, it may be preferred to isolate the monitoring system 130 from the communication network 115.

In a further illustrative implementation, the capturing system 110 may run an operating system able to support one or more virtual computing systems; in this implementation, an exemplary monitoring system 130 may be a virtual computing system running on the capturing system 110 and having no network connections. In some implementations, the capturing system 110 may run an operating system less commonly targeted by viral toolkit users (such as Unix, Linux, and the like), and the monitoring system 130 may run an operating system more commonly targeted by viral toolkit developers (such as Microsoft Windows NT, 2000, XP, and the like). An exemplary capturing system 110 may have one or more network shared storage areas (not shown), which may be created using a Windows-compatible file sharing protocol such as Samba or the like, and may implement a port listening process to detect threats on non-standard ports. In such an exemplary capturing system 110, whenever a file is written or modified on the network shared storage areas of the capturing system 110, a process on the capturing system 110 may copy the file to the monitoring system 130.

The file, and/or any suspicious code (such as email attachments, scripts, and the like) included in the file, may be presumed to comprise malware 120. The monitoring system 130 may then execute the malware 120, using appropriate techniques, as known to those skilled in the art. For example, if the malware 120 comprises suspicious code that is executable, the monitoring system 130 may execute the suspicious code. In another example, if the malware 120 includes suspicious code in Visual Basic scripting language, the monitoring system 130 may launch Visual Basic to execute the suspicious code. Information such as file extensions may be useful to the monitoring system 130 in determining how to execute the malware 120. In some implementations, the administrator 140 may interact with the monitoring system 130 as appropriate to cause the execution of the malware 120. Execution of the malware 120 may create one or more suspicious processes.

The monitoring system 130 monitors selected events representing actions taken by the suspicious processes, and generates a log 150 of information describing the events. In some embodiments, the log 150 is a structured document such as an XML (extensible Markup Language) file.

In an exemplary selection of events to be described in the log 150, the monitoring system 130 may monitor all actions regarding the operating system, file system, and registry components of the monitoring system 130. The suspicious processes may be monitored until their conclusion, or for a selected amount of time (such as an amount of time determined by the administrator 140 to be sufficient to observe activities of the suspicious processes). The monitoring system 130 may then kill the one or more suspicious processes.

In some embodiments, the log 150 is transferred by the monitoring system 130 to the capturing system 110, which may then transfer the log 150 to the administration system 160. In other embodiments, the log 150 is transferred by the monitoring system 130 to the administration system 160. The administration system 160 may utilize the log 150 of information gleaned from the monitoring to generate a script 170 of actions for a suggested remediation or clean-up procedure.

The script 170 may comprise a list of actions recommended or required for reversal of events described in the log 150. In a preferred embodiment, the script 170 is a structured document such as an XML file, or any other format that can be parsed. The XML file format includes a useful ability to nest formatting tags, as one would nest commands in a programming language. In other embodiments, the script 170 may be implemented as a computer program or document comprising any form of text or code. The script 170 may be used, in an illustrative example, as an input to a software application (such as a fix tool or a fix tool builder, discussed in greater detail with respect to FIG. 1B below) that is able to cause instructions to be executed according to the script 170.

In some implementations, the administrator 140 may review the log 150. In other implementations, the log 150 is not reviewed by the administrator 140 before the log 150 is used by the administration system 160 to generate the script 170. The administrator 140 reviews the script 170, and may cause the script 170 to be included or embodied in a fix tool for remediating affected systems.

For ease of illustration, the exemplary implementation depicted in FIG. 1A is one in which a first computer implements the capturing system 110, a second computer implements the monitoring system 130, and a third computer implements the administration system 160. However, it will be apparent to one skilled in the art that the capturing system 110, the monitoring system 130, and the administration system 160 represent functionality that may readily reside together on a single computer, or be divided among a plurality of computers. For example, in some implementations, a single computer may be configured to implement one, any two, or all three of the capturing system 110, the monitoring system 130, and the administration system 160. In other implementations, a plurality of computers may be configured to implement any one or more of the capturing system 110, the monitoring system 130, and the administration system 160.

FIG. 1B is a diagram illustrating data flow for a further embodiment of the invention, in an exemplary implementation that does not include a capturing system 110. A computer 165 is configured to implement the monitoring system 130 and the administration system 160. In some implementations, the monitoring system 130 and/or the administration system 160 may be virtual computing systems running on the computer 165. In other implementations, the monitoring system 130 and/or the administration system 160 are implemented as software applications running under an operating system on the computer 165.

An administrator 140, using an exemplary administration system 160, is able to review and modify a script 170, and generate or build a fix tool 180. The fix tool 180 comprises executable code that may be distributed to affected entities for remediation of the effects of the malware 120, such as by running the fix tool 180 on a computer system that has been affected by the malware 120. The administration system 160 may comprise a software application (e.g., a fix tool builder) for reading the script 170 and creating the fix tool 180. The script 170 may be used, for example, as an input to the fix tool 180. The script 170 may in some implementations be encrypted or obfuscated to hinder unauthorized modification. In some embodiments, the script 170 may be an input to the fix tool builder for generating the fix tool 180. The fix tool 180 is able to cause instructions to be executed according to the script 170.

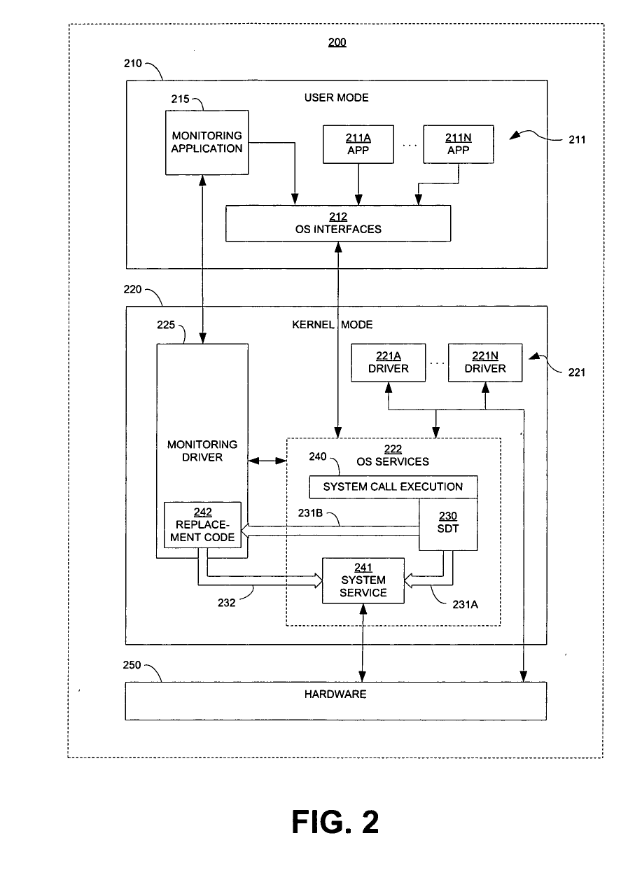

FIG. 2 is a diagram of a computer system 200, such as computer 165, implementing a monitoring system 130 according to an illustrative embodiment of the invention. The monitoring system 130 is able to make detailed information on a new malware 120 immediately available from watching a live infection of malware 120. By monitoring activity initiated by the malware 120 in a live environment, the administrator 140 can learn, for example, what registry values are modified by the malware 120, what files are affected by the malware 120, and what network usage is implemented by the malware 120. Such information may be recorded in log 150, and may be used to create an effective fix tool 180.

The monitoring system 130 comprises a monitoring driver 225 running in kernel mode 220. The monitoring system 130 may also comprise a monitoring application 215 running in user mode 210, for providing a user interface to the monitoring driver 225. The computer 165 may run a conventional operating system such as Microsoft Windows NT, 2000, or XP (collectively referred to hereinafter as “Windows NT”) and the like, in which software applications are designed to run in user mode 210 or in kernel mode 220. Kernel mode 220 is a highly privileged memory access mode, and user mode 210 is a less privileged memory access mode.

The monitoring driver 225 is adapted to monitor activity of the computer 165, and particularly activity initiated by the malware 120, by hooking system services (such as operating system services 222) of the operating system. Methods for hooking system services have been previously implemented under Windows NT and other operating systems. Hooking is a well-known way to intercept a call or request to a system service, and to be able to modify the behavior of the computer 165 in response to the call or request. For example, hooking allows additional functionality to be interposed before and/or after the performance of the requested system service.

An exemplary monitoring driver 225 is shown, for illustrative purposes, hooking system calls in a conventional fashion on a Windows NT operating system. However, as will be appreciated by one skilled in the art, the generic principles defined herein may be applied to other operating systems, embodiments, and applications without departing from the spirit and scope of the invention.

Exemplary software running in user mode 210 on the computer 165 may include software applications such as applications 211A . . . 211N (collectively, applications 211). Exemplary software running in kernel mode 220 on the computer 165 may include drivers 221A . . . 221N (collectively, drivers 221). As is known in the art, one of the drivers 221 may communicate with another of the drivers 221 in an object-oriented fashion. Drivers 221 may, for example, include virtual device drivers for accessing functions of hardware 250.

The applications 211 do not have direct access to the hardware 250, but may indirectly access the hardware 250 by calling standard services that are provided by the operating system. Numerous system calls, such as system calls for implementing services such as creating, reading, and writing files on the hardware 250, may be made available by an operating system; for example, through one or more operating system interfaces 212. In an illustrative example, operating system interfaces 212 running in user mode 210 under Windows NT may include APIs and/or wrapper functions, such as those provided in standard dynamic link libraries such as KERNEL32.DLL and/or NTDLL.DLL. An exemplary operating system interface 212 may request execution of the requested system service, such as by issuing an interrupt that causes the computer 165 to enter kernel mode 220 for accessing operating system services 222.

Exemplary operating system services 222 include a system call execution 240 service, such as an operating system executive (e.g., the Windows NT Executive included in the standard Windows NT file NTOSKRNL.EXE, or the like), which may in some implementations comprise an interrupt handler, exception handler, and/or system call layer (not shown). The operating system services 222 may provide access to numerous system services (such as exemplary system service 241) that are accessible through system call execution 240. System services may, for example, include file system services, registry management services, process management services, virtual memory management services, I/O management services, and the like. An exemplary system service 241 may in some implementations be provided by or through one or more of the drivers 221, and/or a hardware abstraction layer (not shown) for accessing hardware 250.

Each of the system services provided by operating system services 222 is generally accessed through one or more layers of indirection using one or more pointers, such as through a service descripting table (SDT) 230. For example, in an implementation under Windows NT, a conventional SDT 230 contains a pointer to a system service dispatch table (not shown), containing one entry for each of the system services. Each entry includes a pointer to an object or function (such as a function in one of the drivers 221) for implementing the system service corresponding to the entry, such as exemplary system service 241.

The monitoring driver 225 is adapted to hook system services. In an exemplary implementation under Windows NT, the monitoring driver 225 hooks system services by modifying the values of pointers that may be accessed through the SDT 230.

In an illustrative example prior to hooking, pointer 231A represents an unmodified entry in the system service dispatch table of the SDT 230. Pointer 231A points to the system service 241, which will be executed by the operating system services 222 when a system call is received that requests execution of the system service 241.

In an illustrative example after hooking, pointer 231B represents a modified entry in the system service dispatch table of the SDT 230. Pointer 231B points to replacement code 242 (such as a function or object) which may be located in the monitoring driver 225. The code pointed to by pointer 231B is executed instead of the system service 241. The replacement code 242 will be executed by the operating system services 222 when a system call is received that requests execution of the system service 241. Pointer 232 points back to the original system service 241, which may be called by the replacement code 242. It should be noted that although the illustrated example depicts a pointer 231B that points to replacement code 242 in the monitoring driver 225, in some embodiments, the replacement code 242 may be located elsewhere, such as in one of the drivers 221 or in the monitoring application 215.

The replacement code 242 enables information about the system call to be recorded in the log 150. In a preferred embodiment, the information is entered into the log 150 before the replacement code 242 calls the original system service 241 for execution; however, the information may in some embodiments be logged during or after execution of the original system service 241, or instead of executing the original system service 241. In a preferred embodiment, the replacement code 242 causes the monitoring application 215 to add information to the log 150 that describes the requested system call (such as an identifier for the requested system service, values of one or more parameters, and such other pertinent information as may be available concerning the requested system call). In some embodiments, the monitoring application 215 may be able to display information from the log 150 to the administrator 140 as events are logged.

In further embodiments, the replacement code 242 may request a permission from the monitoring application 215 (such as by checking a setting of the monitoring application 215, or by causing the monitoring application 215 to interact with the administrator 140 for obtaining such permission), such that the system service 241 will be executed only if the permission is granted. The replacement code 242 may, for example, pause before execution of the system service 241 by blocking (waiting) until permission is received from monitoring application 215, thereby allowing the administrator 140 to proceed at a desired pace. The replacement code 242 may also be able to terminate execution of a suspicious process that originated the system call (for example, based upon a signal, flag, input, or the like received from monitoring application 215), thereby allowing the administrator 140 an opportunity to halt harmful activity of the malware 120 rather than to permit such activity to occur.

In another illustrative example, permission may be denied by the monitoring application 215 based upon a selection of one or more events that are not permitted, such as harmful events that may be selected by the administrator 140 and maintained (e.g., as a list or a stored setting) by the monitoring application 215. Examples of such events may include attempts to delete all of the files on a data storage device of the computer 165, or attempts to delete one or more files matching a selected pattern or criterion (such as operating system files, or files otherwise identified by the administrator 140), and the like.

By allowing replacement code 242 to be interposed for one or more selected system calls (such as a call to exemplary system service 241), the monitoring system 130 enables detailed monitoring and logging of activity of the computer 165, including activity initiated by the malware 120. In some embodiments, the monitoring driver 225 is able to monitor the computer 165 for a new or unidentified process. A controlled software environment may be provided in the computer 165, so that the appearance of a new or unidentified process may be deemed suspicious (i.e., presumed to be initiated by the malware 120). The monitoring driver 225 may then monitor activity initiated by the suspicious process, including subprocesses thereof, rather than monitor all activity of the computer 165.

In other embodiments, the monitoring driver 225 is able to monitor one or more directories or file systems (which may be local or networked) of the computer 165 for the creation, renaming, or deletion of one or more files or directories. In some implementations, a service in user mode 210 may be provided for watching or monitoring such directories or file systems. The service in user mode 210 may be included in the monitoring application 215, or may be provided separately; for example, one of the applications 211 may be configured to notify the monitoring application 215 of an event such as the creation, renaming, or deletion of one or more files or directories. A controlled software environment may be provided in the computer 165, so that the appearance of a new file may be deemed suspicious (i.e., presumed to be initiated by the malware 120). The new file, and/or any suspicious code (such as email attachments, scripts, and the like) included in the new file, may be presumed to comprise malware 120. The monitoring application 215 may then cause the monitoring system 130 to execute the malware 120. Execution of the malware 120 may create one or more suspicious processes. The monitoring driver 225 may then monitor activity initiated by the suspicious process, including subprocesses thereof, rather than monitor all activity of the computer 165.

When the monitoring application 215 receives information from the monitoring driver 225 indicating that a requested system call will modify or delete one or more registry values or information in a file or file system of the computer 165, the monitoring application 215 is able to preemptively back up such registry values, file information, and/or file system information before they are modified or deleted. In this way, the modified or deleted information may be able to be restored by the fix tool 180 as part of the remediation, if desired. Such information may be incorporated in the log 150, or may be recorded in one or more separate files (such as backup files) which may be referenced by the log 150, or which may comprise supplementary portions of the log 150.

For example, in an illustrative embodiment of the monitoring application 215, if a requested system call will delete a file or delete a directory, the monitoring application 215 may back up the file or directory to a secure location. In another example, if a requested system call will delete a registry value or a registry key, the monitoring application 215 may back up the applicable registry information to a secure location, such as a backup registry location. In a further example, if a requested system call will create a registry value, the monitoring application 215 may check if the registry value already exists, and store the information from that check in a location reserved for storing prior status.

The information recorded in the log 150 by the monitoring application 215 may also include network usage and packet information that may be useful for generating IDS signatures, such as for network-based and host-based IDS tools, to assist in protecting against further spread of the malware 120.

In some embodiments, the monitoring application 215 may include an interface (such as a graphical user interface) for displaying the log 150 to the administrator 140, and enabling the administrator 140 to review contents of the log 150. The administrator 140 may review and/or edit the log 150 as desired, to facilitate the creation of an acceptable script 170 and/or fix tool 180. The administrator 140 may use the monitoring application 215 (or, in some implementations, a suitable one of the applications 211, such as a word processor or an XML editor) for viewing and/or editing the log 150.

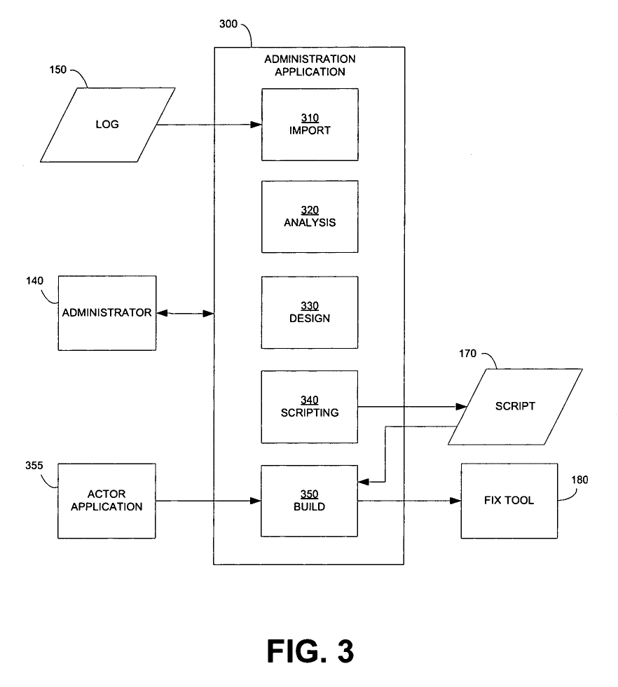

FIG. 3 is a diagram of an administration application 300 configured to generate a fix tool 180 according to an illustrative embodiment of the invention. The administration application 300 is able to operate in user mode 210 of a computer system such as computer 165. In some embodiments, the administration application 300 and the monitoring application 215 may be implemented as separate software applications; in other embodiments, a single software application may implement both the administration application 300 and the monitoring application 215.

The exemplary administration application 300 includes import functionality 310 for receiving information from log 150, such as by reading XML statements in the log 150. In some embodiments, the log 150 may be received by the import functionality 310 from the monitoring application 215 or from the monitoring driver 225 (such as through a socket, stream, interprocess communication, or the like) during the operation of the monitoring driver 225. In such embodiments, the administrator 140 may be able to interactively control or influence the operation of the monitoring driver 225 as the log 150 is received in real-time.

In other implementations, the import functionality 310 is able to read a file comprising the log 150. In still further implementations, there may be no log 150 provided, and the administrator 140 may instead use design functionality 330 to select features of a script 170 that are desired by the administrator 140 (such as according to remediation information provided by an antivirus vendor).

The exemplary administration application 300 may include analysis functionality 320 for allowing the administrator 140 to select, filter, and/or review contents of the log 150. The analysis functionality 320 of the administration application 300 may in some embodiments include all or a portion of the functionality of the monitoring application 215. Analysis functionality 320 may, for example, include a graphical user interface for displaying information relating to entries in the log 150, such as events recorded by the monitoring application 215.

Design functionality 330 of the exemplary administration application 300 provides to the administrator 140 an interface, such as a point-and-click graphical user interface, for generating a script 170. For example, in the absence of a log 150, an administrator 140 can use design functionality 330 to generate a script 170 utilizing steps for remediation (such as manual clean-up steps provided by an antivirus vendor). The administrator 140 need not have programming knowledge to use the design functionality 330. Whether or not a log 150 is provided, the administrator 140 may create or modify the script 170 using the design functionality 330.

The administrator 140 may design the script 170 by selecting functions to be included in the script 170, such as by using the interface to make selections and to specify values for parameters. In an illustrative example, the administrator 140 may select registry functions, such as add keys, delete keys, add values, delete values, modify values, search for values, and the like. In a further example, the administrator 140 may select process management functions, such as start service, stop service, install service, uninstall service, start process, kill process, and the like. In a still further example, the administrator 140 may select file or file system functions, such as create directory, delete directory, create file, delete file, read file, write file, and the like. The administrator 140 may arrange or rearrange the selected functions in the script 170 into a desired order for execution by the fix tool 180. In some embodiments, the administrator 140 may provide a name or title for the script 170, such as a descriptive name indicating a purpose of the script 170 (e.g., “ABCD Virus Removal”), which may, for example, be displayed by the fix tool 180.

Scripting functionality 340 of the exemplary administration application 300 generates a script 170. The script 170 may be a structured document such as an XML file. The script 170 may in some implementations be encrypted or obfuscated to hinder unauthorized modification. The script 170 may be created, adjusted, and/or modified according to choices made by the administrator 140 using the design functionality 330. In some embodiments, the scripting functionality 340 is able to automatically create a script 170 containing entries for reversing, undoing, and/or remediating events recorded in the log 150, such as events that are presumed to be effects of the malware 120. In an illustrative example, the scripting functionality 340 may automatically respond to an entry in the log 150 describing deletion of a file by creating a corresponding entry in the script 170 to remediate the deletion of the file. For example, the corresponding entry in the script 170 may restore the original file, using a copy of the original file, if such a copy was previously stored by the monitoring application 215 (e.g., a copy incorporated in the log 150, or recorded in one or more separate backup files referenced by the log 150, or comprising supplementary portions of the log 150).

In an illustrative example, scripting functionality 340 retrieves descriptive information contained in the log 150 and creates a script 170 for implementing a suggested cleanup routine based on the descriptive information. It will be apparent to those skilled in the computer programming art that scripting functionality 340 may be programmed in a variety of ways to generate the script 170 in accordance with the above-described procedure. One example of pseudocode for carrying out scripting functionality 340 is set forth below.

For Each Entry in LOG

If Action = DeleteFile || Delete Directory

Create Script Action (Retrieve Backup and Restore)

If Action = DeteleteRegValue

Create Script Action(Restore reg value from backup)

If Action = DeleteRegKey

CreateScriptAction(restore reg key from backup)

If Action = CreateRegKey

If PriorStatus = Already Exists

Next

Else

CreateScriptAction(DeleteRegKey)

If Action = CreateRegValue

If PriorStatus = AlreadyExists

Next

Else

CreateScriptAction(DeleteRegValue)

If Action = StartProcess

CreateScriptAction(KillProcess)

If Action = CreateFile

CreateScriptAction(DeleteFile)

...

End For

Note that the foregoing exemplary pseudocode does not attempt to illustrate or describe all the various functionality of the scripting functionality 340, but only selected functionality related to aspects of the present invention. The foregoing pseudocode is provided for illustration purposes, and not to, in any way, limit the present invention to a particular type of implementation.

The administrator 140 is able to review and/or modify the script 170. For example, the administrator 140 may engage in one or more cycles of using scripting functionality 340 to generate a script 170, and using design functionality 330 to review and/or modify the script 170, as may be desired. When the administrator 140 is satisfied with the script 170, the administrator 140 may use build functionality 350 to generate a fix tool 180 using the script 170.

Build functionality 350 of the exemplary administration application 300 generates a fix tool 180. The fix tool 180 comprises distributable executable code, such as actor application 355, that utilizes the script 170 to perform actions, such as actions useful for removing malware 120 and remediating effects of malware 120. An exemplary actor application 355 is a redistributable user-mode application that is able to read the script 170 as an input, and able to perform steps described in the script 170. In some implementations, the build functionality 350 creates the fix tool 180 by packaging the script 170 and the actor application 355 together in the form of a self-extracting executable archive. The self-extracting executable archive comprises the fix tool 180. Examples of commercially available tools that may be used for building a self-extracting executable archive include WinZip, PKZip, and the like.

In further implementations, the build functionality 350 may be able to use the script 170 to compile or otherwise build an executable fix tool 180 comprising an actor application 355 adapted to perform steps described in the script 170. In such implementations, the actor application 355 may incorporate the script 170, thereby making it unnecessary to distribute the script 170 as a file distinct from the actor application 355.

In an illustrative example, the fix tool 180 may be distributed to personnel of an affected entity, such as end users (not shown). The fix tool 180 may be used by such personnel on their computer systems to remediate effects of a malware 120. For example, after a malware 120 is detected, the fix tool 180 can quickly be distributed to end users who may then immediately start cleaning their computer systems of the effects of the malware 120. In another illustrative example, the fix tool 180 may be designed and utilized to remove applications other than malware 120, such as applications that do not uninstall cleanly.

In an exemplary implementation of a fix tool 180 provided as a self-extracting executable archive, an end user runs the fix tool 180. The fix tool 180 extracts the actor application 355 and the script 170 (such as an XML file), and begins execution of the actor application 355. An exemplary actor application 355 may display a title (such as the file name of the script 170, or a title contained in the script 170) in a user interface of the actor application 355. The end user may cause the actor application 355 to execute the steps described in the script 170; for example, the actor application 355 may provide a button labeled “Start,” and upon detecting that the end user has clicked on the button, the actor application 355 may begin performing the steps described in the script 170. In another implementation, the fix tool 180 or the actor application 355 may be configured to automatically begin execution, such as with a command line switch, upon startup of a computer system. In some implementations, the actor application 355 may display descriptive information relating to each step, which may include a status indicator showing if the step was successful or not. In further implementations, the actor application 355 may create a troubleshooting log containing descriptive information relating to each step; such a troubleshooting log may, for example, be a plain text or XML file.

It will be apparent to those skilled in the computer programming art that a fix tool 180 and actor application 355 may be programmed in a variety of ways to perform steps described in the script 170 in accordance with the above-described procedure. One example of pseudocode for carrying out a fix tool 180 comprising an actor application 355 is set forth below.

Application startup
Extract script file from archive to temporary file
Read script from temporary file into memory
Parse script into multi-dimensional array for configuration
settings

Obtain fix tool title

Display interface with fix tool title from script
If (option=silent) or (no GUI) or (user pressed start button)

While array(commands)

Select case command

Case registry action

perform action on specified registry key

Case file system action

perform action on specified file/directory

Case process action

enumerate running processes
if running_process = array(process_match)

perform action on specified process

end if running_process

...

End select

End while loop

End if

Note that the foregoing exemplary pseudocode does not attempt to illustrate or describe all the various functionality of a fix tool 180 and actor application 355, but only selected functionality related to aspects of the present invention. The foregoing pseudocode is provided for illustration purposes, and not to, in any way, limit the present invention to a particular type of implementation.

In some implementations, the fix tool 180 may be characterized as a quick-and-dirty tool for assisting an affected entity in prompt remediation of the effects of a malware 120. Accordingly, in addition to using a fix tool 180 according to an embodiment of the present invention, personnel of an affected entity may, if desired, use other remediation tools that may be provided by an antivirus vendor, as well as antivirus software for preventing the spread of the malware 120.

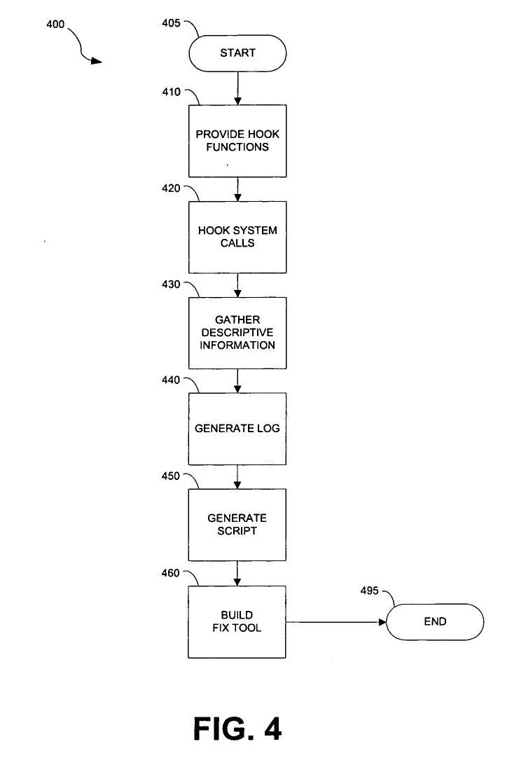

FIG. 4 shows a method 400 for remediating effects of a malware 120 according to an embodiment of the present invention. The method 400 begins at start block 405, and proceeds to block 410. At block 410, one or more hook functions, such as replacement code 242, are provided by the monitoring driver 225.

At block 420, one or more system calls, such as a call to exemplary system service 241, are hooked by the monitoring driver 225.

At block 430, descriptive information is gathered, such as by replacement code 242, concerning the one or more system calls. The monitoring application 215 may receive the descriptive information from the monitoring driver 225.

At block 440, a log 150 is generated by the monitoring application 215. The log 150 may comprise at least a portion of the descriptive information previously gathered.

At block 450, a script 170 is generated. The administration application 300 may generate the script 170, using the scripting functionality 340. The script 170 may comprise remediation information for effects of the malware 120 that are described in at least a portion of the log 150.

At block 460, a fix tool 180 is built. The administration application 300 may build the fix tool 180, using the build functionality 350. The fix tool 180 is able to perform remediation actions according to the script 170. The method 400 then concludes at block 499.

In an implementation of one embodiment of the invention, an exemplary monitoring driver 225, a software application for implementing an exemplary administration application 300 and exemplary monitoring application 215, and a fix tool 180 have been tested. The test implementation was developed using Microsoft Visual C++6.0 in a Windows NT system, utilizing conventional functions for XML file generation and creation of self-extracting executable files.

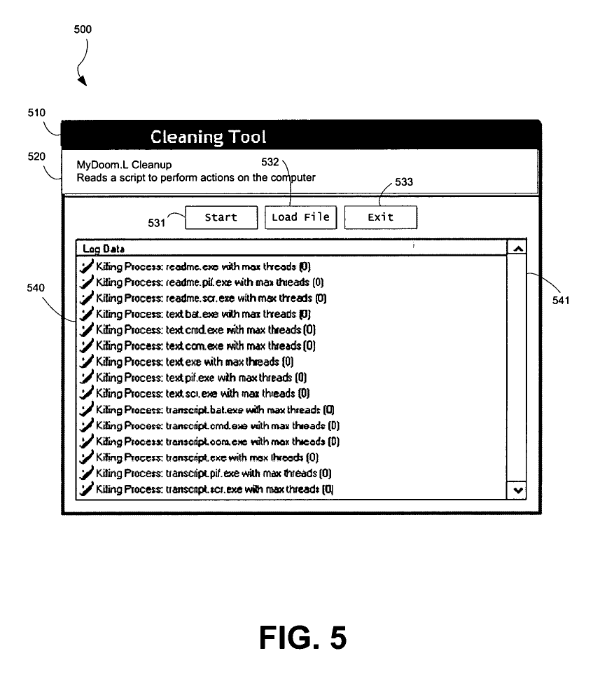

FIG. 5 is a depiction of an exemplary user interface 500 for a fix tool 180 according to an embodiment of the present invention. The exemplary user interface has a title bar 510, a descriptive title area 520, a start button 531, a load file button 532 for loading a script 170, an exit button 533, and a status window 540 with a scroll bar 541. When an end user (such as administrator 140) clicks on the load file button 532, a selection of available scripts 170 may be displayed for selection. When the end user clicks on the start button 531, the actor application 355 of fix tool 180 begins to execute the steps described in the script 170, and may display the status of each step in status window 540.

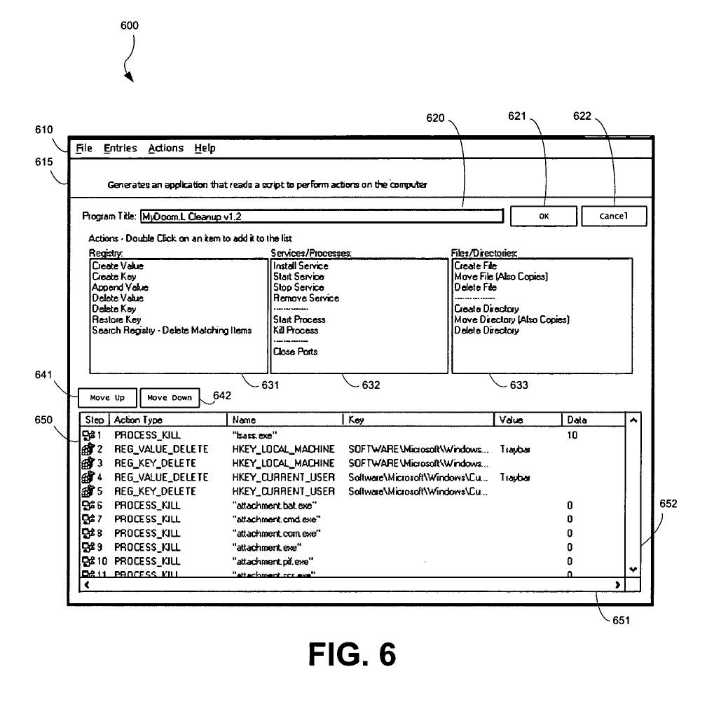

FIG. 6 is a depiction of an exemplary user interface 600 for design functionality 330 and build functionality 350 of an administration application 300 according to an embodiment of the present invention. The exemplary user interface has a menu bar 610, and a descriptive title area 615. Exemplary controls for build functionality 350 include an input area 620 for entry of a filename for a script 170 to be built, an OK button 621 to initiate building of the script 170 according to a list of steps shown in script display panel 650), and a cancel button 622 to cancel building of the script 170. Exemplary controls for design functionality 330 include selection panels 631-633 for displaying one or more selectable lists of actions to be included in the script 170. Registry panel 631 displays a selectable list of actions concerning the registry; services/processes panel 632 displays a selectable list of actions concerning services and processes; files/directories panel 633 displays a selectable list of actions concerning files and directories. In an exemplary implementation, double-clicking on an action will cause a step corresponding to the action to be added to script display panel 650. Script display panel 650 displays steps that will be included in the script 170, which may be displayed in the order that the steps will be performed by the fix tool 180. A user may select one or more steps in the script display panel 650, and click on the up button 641 to move the step upward (thereby changing the order of execution), or the down button 642 to move the step downward (thereby changing the order of execution). Script display panel 650 may include descriptive and/or functional information concerning each step, and scroll bars 651, 652 for scrolling the display of steps.

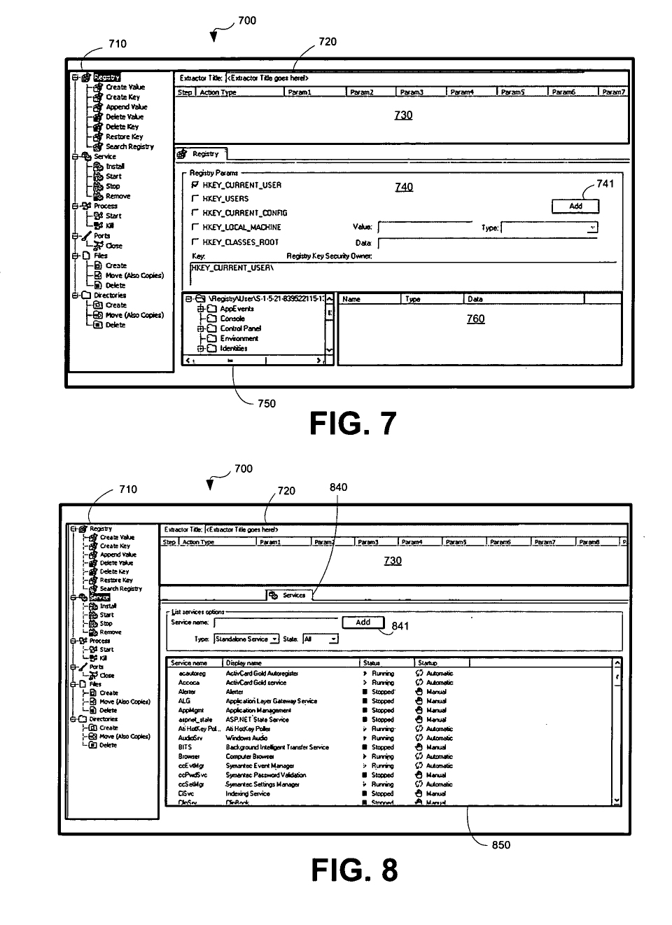

FIG. 7 is a depiction of an exemplary user interface 700 for an administration application 300, illustrating registry management features according to an alternate embodiment of the invention. Navigation panel 710 depicts categories of design functionality 330 in a tree structure, such that the user may select a category (such as by clicking or double-clicking on the category), and the user interface 700 will display information relevant to the selected category. In the illustration, a registry category is selected in the navigation panel 710.

An area of the user interface 700 may be provided for build functionality 350, such as input area 720 for entry of a filename for a script 170 to be built, and script display panel 730. Script display panel 730 displays steps that will be included in the script 170, which may be displayed in the order that the steps will be performed by the fix tool 180. Script display panel 730 may include descriptive and/or functional information concerning each step, and scroll bars (not shown) for scrolling the display of steps.

Registry management features may include a registry parameter area 740 having one or more selection tools (such as checkboxes, input areas, and/or menus) for selecting registry keys, and input areas for entering a value, type, and/or data associated with the selected registry keys, for designing a desired change to the registry. An add button 741 may be provided for causing a step corresponding to the desired change to be added to script display panel 730. Other selection tools may be provided, such as registry navigation panel 750, which depicts the registry in a tree structure, such that the user may walk the registry tree (such as by clicking or double-clicking on a key or a subkey), and a registry viewing panel 760 may display information relevant to a selected registry key.

FIG. 8 is a depiction of an exemplary user interface 700 for an administration application 300, illustrating service analysis features according to an alternate embodiment of the invention. In the illustration, a service category is selected in the navigation panel 710.

Analysis functionality 320 may include service analysis features such as a service display panel 850. The service display panel 850 may include descriptive and/or functional information concerning services, such as a display name, status, and startup information for a service. An options area 840 may be provided, for selecting which services are visible in the service display panel 840. An add button 841 may be provided for adding a specified service to the service display panel 840.

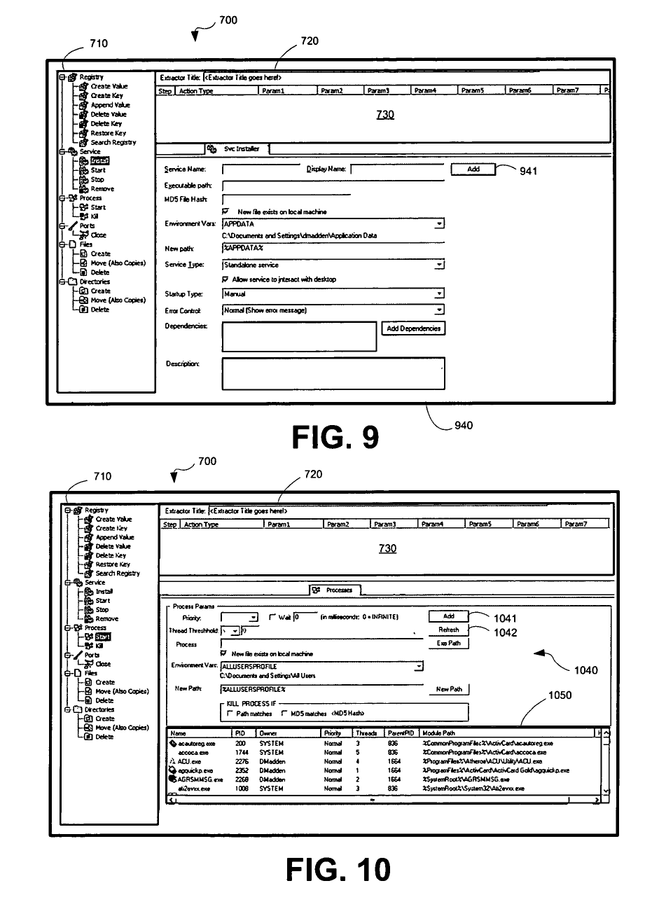

FIG. 9 is a depiction of an exemplary user interface 700 for an administration application 300, illustrating service installer features according to an alternate embodiment of the invention. In the illustration, a service installer category is selected in the navigation panel 710.

Service installer features may include a service specification area 940 for selecting and/or describing features of the service for which installation is desired. The service specification area 940 may include input areas and/or menus for entering features or parameters such as a service name, executable path, MD5 file hash, environment variables, new path, service type, startup type, error control type, dependencies, descriptive text, and the like. associated with the selected registry keys, for designing a desired change to the registry. An add button 941 may be provided for causing a step corresponding to the desired service installation to be added to script display panel 730.

FIG. 10 is a depiction of an exemplary user interface 700 for an administration application 300, illustrating process start features according to an alternate embodiment of the invention. In the illustration, a process start category is selected in the navigation panel 710.

Process start features may include a process specification area 1040 for selecting and/or describing features of the process for which starting is desired. The process specification area 1040 may include input areas and/or menus for entering features or parameters such as a priority, wait time (for which an entry of zero may be taken to mean an infinite wait), thread threshold, process name, executable path, environment variables, new path, and the like. The process specification area 1040 may also include one or more selection tools (such as checkboxes, input areas, and/or menus) for selecting when to kill the process. An add button 1041 may be provided for causing a step corresponding to the desired process starting action to be added to script display panel 730.

Analysis functionality 320 may include service analysis features such as a process display panel 1050. The process display panel 1050 may include descriptive and/or functional information concerning running processes, such as a name, process id (PID), owner, priority, number of threads, parent PID, and module path. A refresh button 1042 may be provided for causing the process display panel 1050 to be updated or refreshed.

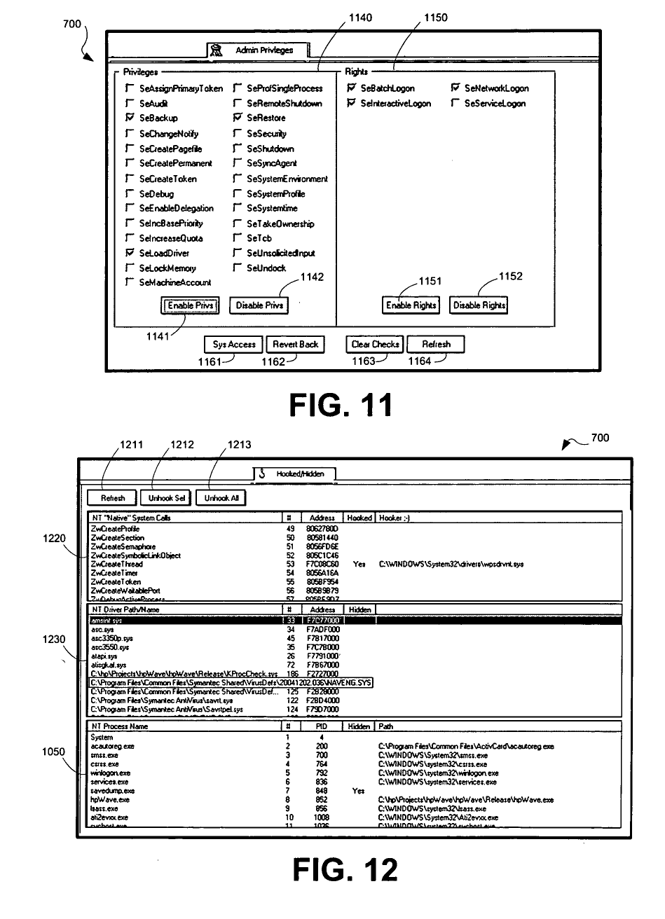

FIG. 11 is a depiction of an exemplary user interface 700 for an administration application 300, illustrating privilege features according to an alternate embodiment of the invention. Privileges panel 1140 may include one or more selection tools (such as checkboxes, input areas, and/or menus) for selecting an administrative privilege to turn on or off. Rights panel 1150 may include one or more selection tools (such as checkboxes, input areas, and/or menus) for selecting a logon right to turn on or off. An enable privileges button 1141 and a disable privileges button 1142 may be provided for causing the operating system to enable or disable, respectively, the selected privileges in privileges panel 1140. An enable rights button 1151 and a disable rights button 1152 may be provided for causing the operating system to enable or disable, respectively, the selected logon rights in privileges panel 1150.

A system access button 1161 may be provided for requesting system access with the selected privileges and logon rights. A revert back button 1162 may be provided for reverting to a previously selected state of privileges and logon rights. A clear checks button 1163 may be provided for causing previous selections to be cleared. A refresh button 1164 may be provided for causing the privileges panel 1140 and rights panel 1150 to be updated or refreshed.

FIG. 12 is a depiction of an exemplary user interface 700 for an administration application 300, illustrating analysis functionality 320 according to an alternate embodiment of the invention. Analysis functionality 320 may include monitoring features such as a system call display panel 1220, a driver display panel 1230, and a process display panel 1050. The process display panel 1050 is described above with reference to FIG. 10.

The system call display panel 1220 may display a list of information concerning system services (such as exemplary system service 241). Such information may include a name (e.g., an API function name), a number associated with the system service, an address for executing the system service (such as a value of an appropriate one of the pointers 231A, 231B), whether the system service is hooked, and identifying information for a driver, service, or process that has hooked the system service.

The driver display panel 1230 may display a list of information concerning drivers (such as drivers 221). Such information may include a file name (which may include a path), a number associated with the driver, an address for executing the driver, and whether the driver is hidden.

A refresh button 1211 may be provided for causing the system call display panel 1220, driver display panel 1230, and process display panel 1050 to be updated or refreshed. An unhook selection button 1212 may be provided for causing the monitoring driver 225 to unhook a selected system service, such as by restoring a pointer accessible through the SDT 230 to the original value (such as the value of pointer 231A). An unhook all button 1213 may be provided for causing the monitoring driver 225 to unhook all system services that the monitoring driver 225 had previously hooked.

Although exemplary implementations of the invention have been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A system for remediating effects of an undesired application, comprising:
a script generator able to generate a script comprising remediation information corresponding to one or more actions for remediating one or more effects of the undesired application, and
a fix tool builder able to generate a fix tool for performing the one or more actions.

2. The system of claim 1 wherein the undesired application comprises malware.

3. The system of claim 1 wherein the script comprises statements in an extensible markup language.

4. The system of claim 1 wherein the script generator further comprises an administration application able to receive descriptive information concerning the one or more effects.

5. The system of claim 4 wherein the descriptive information comprises one or more entries in a log.

6. The system of claim 5 wherein the log comprises statements in an extensible markup language.

7. The system of claim 5 wherein the administration application is able to import the log.

8. The system of claim 4 wherein the administration application comprises an administration interface for receiving at least a portion of the descriptive information.

9. The system of claim 4 wherein the administration application comprises an administration interface for editing the descriptive information.

10. The system of claim 1 further comprising a monitoring driver able to hook one or more system calls of the undesired application.

11. The system of claim 1 further comprising a monitoring application able to receive descriptive information concerning one or more system calls of the undesired application, and able to generate a log comprising descriptive information concerning the one or more effects.

12. The system of claim 11 further comprising
a monitoring driver able to hook the one or more system calls for providing the descriptive information to the monitoring application.

13. The system of claim 1 further comprising a user interface able to receive at least a portion of the remediation information.

14. The system of claim 13 wherein the user interface comprises a capability for editing the script.

15. The system of claim 1 wherein the fix tool comprises the script and an actor application able to read the script and perform the actions.

16. The system of claim 1 wherein the fix tool comprises an actor application able to perform the one or more actions.

17. A system for remediating effects of an undesired application, comprising
an analysis application able to receive descriptive information concerning one or more effects of the undesired application, and
a script generator able to use the descriptive information for generating a script comprising remediation information describing one or more actions for remediating the one or more effects.

18. The system of claim 17 wherein the descriptive information comprises one or more entries in a log.

19. The system of claim 17 further comprising a monitoring driver for providing the descriptive information.

20. The system of claim 19 wherein the monitoring driver is able to hook one or more system calls.

21. The system of claim 17 wherein the analysis application comprises a viewing interface for displaying at least a portion of the descriptive information.

22. The system of claim 17 wherein the analysis application comprises an editing interface for modifying at least a portion of the descriptive information.

23. The system of claim 17 wherein the script generator comprises an editing interface for modifying at least a portion of the remediation information.

24. A monitoring system for effects of an undesired application, comprising
a monitoring driver able to hook one or more system calls of the undesired application,
one or more hook functions for gathering descriptive information concerning the one or more system calls potentially affected in a malicious way by the undesired application, and
a monitoring application able to receive the descriptive information, and able to generate a log comprising descriptive information concerning the one or more potentially malicious effects.

25. The system of claim 24 wherein the monitoring application comprises a viewing interface for displaying at least a portion of the descriptive information.

26. The system of claim 24 wherein the monitoring application comprises an editing interface for modifying at least a portion of the descriptive information.

27. A method for remediating effects of an undesired application, comprising
providing one or more hook functions,
hooking one or more system calls,
gathering descriptive information concerning the one or more system calls,
generating a log comprising at least a portion of the descriptive information,
generating a script comprising remediation information for at least a portion of the log, and
building a fix tool able to perform remediation actions according to the script.

28. The method of claim 27 further comprising reviewing the log.

29. The method of claim 27 further comprising editing the script.

30. The method of claim 27 further comprising performing remediation actions according to the script.

31. The method of claim 27 wherein the remediation actions include removing the undesired application.

32. A fix tool built according to the method of claim 27.

33. A computer-readable medium containing a set of instructions for remediating effects of an undesired application, the set of instructions comprising steps for:
providing one or more hook functions,
hooking one or more system calls,
gathering descriptive information concerning the one or more system calls,
generating a log comprising at least a portion of the descriptive information,
generating a script comprising remediation information for at least a portion of the log, and
building a fix tool able to perform remediation actions according to the script.

34. The medium of claim 33, the set of instructions further comprising steps for providing a graphical interface for viewing the log.

35. The medium of claim 33, the set of instructions further comprising steps for providing a graphical interface for editing the script.

36. A remediation tool for remediating effects of an undesired application, comprising
a script comprising remediation information for remediating one or more effects of the undesired application, and
an actor application able to perform one or more actions described in the script.

37. The remediation tool of claim 36 wherein the script comprises statements in an extensible markup language.

38. The remediation tool of claim 36 wherein a self-extracting executable file contains the actor application.

39. The remediation tool of claim 38 wherein the self-extracting executable file contains the script.

40. The remediation tool of claim 36 wherein the actor application is configured to display descriptive information relating to the one or more actions.

41. The remediation tool of claim 36 wherein the actor application is configured to log descriptive information relating to performance of the one or more actions.
